(19) United States
(12) Patent Application Publication
(10) Pub. No.: US 2018/0051820 A1
(43) Pub. Date: Feb. 22, 2018

(54) RIGHT ANGLE VALVE

(71) Applicant: KING LAI HYGIENIC MATERIALS CO., LTD, HSINCHU COUNTY (TW)

(72) Inventor: CHI-CHE HUANG, HSINCHU COUNTY (TW)

(21) Appl. No.: 15/242,954

(22) Filed: Aug. 22, 2016

(51) Int. Cl. F16K 27/02; F16K 1/12; F16K 31/122

(52) U.S. Cl. CPC F16K 27/02; F16K 31/1221; F16K 1/126

(57) ABSTRACT

A right angle valve includes a valve body having a cavity, a first pipe and a second pipe connected therewith; a fixing member fixed to the valve body, having a combining end inserted into the cavity; a disc spring having one end combined to the combining end and the other end connected with a sealing member for sealing an inner end of the first pipe; a cover body fixed on one end of the valve body away from the first pipe; a piston member slidingly disposed in the cover body with one end thereof combined to the sealing member, and a covering measure. When the piston member drives the sealing member to move away from the inner end of the first pipe to enable the air flow, the covering measure covers the disc spring, preventing the disc spring from exposure to the flowing air, avoiding an obstruction.

### BACKGROUND OF THE INVENTION

### 1. Field of the Invention

The present invention relates to right angle valves, and more particularly, to a right angle valve capable of covering the disc spring in order to prevent the disc spring from being stuck by other objects and facilitate the position recovering operation thereof.

### 2. Description of the Related Art

Referring to FIG. 1, a sectional view of a known right angle valve is shown. The known right angle valve is used to adjusting or block the air flowing in a vacuum system. The known right angle valve often includes a three way pipe 1, a piston 2, a controlling shaft 3, and a valve plate 4. The piston 2 is movably disposed on one end of the three way pipe 1. One end of the controlling shaft 3 is connected to the piston 2, with the other end thereof connected to the valve plate 4 for controlling the valve plate 4 to open or close the three way pipe 1. Also, a disc spring 5 is disposed between the valve plate 4 and the controlling shaft 3, so as to provide a position recovering force to the piston 2.

When the piston 2 is driven due to an air pressure, the piston 2 forces the controlling shaft 3 to move, thereby triggering the valve plate 4 to allow the connection in the three way pipe 1; at the meantime, the disc spring 5 is compressed. When the air pressure is removed, with the resilient force provided by the disc spring 5, the piston 2 moves to make the valve plate 4 block the connection in the three way pipe 1. With such operation, the air inflow and outflow are achieved. However, during the air inflow and outflow, the air might contain a certain amount of impurities, foreign matter, or dust, such objects are easily stuck on or attached to the disc spring 5. As a result, the movement of the disc spring 5 is kept from being facilitate, failing to accomplish a compete position recovering operation.

### SUMMARY OF THE INVENTION

For improving such issues, an embodiment of the present invention discloses a right angle valve, which applies a covering measure to cover the disc spring when the air inflow is permitted, so as to prevent the disc spring from being stuck by foreign objects and facilitate the operation thereof.

For achieving the aforementioned objectives, an embodiment of the present invention provides a right angle valve, comprising:

a valve body including a cavity and a first pipe and a second pipe that are connected with the cavity;

a fixing member fixed to the valve body, the fixing member provided with a combining end inserted into the cavity;

a disc spring with one end combined to the combining end and the other end connected with a sealing member for sealing an inner end of the first pipe;

a cover body fixed to an end of the valve body away from the first pipe;

a piston member slidingly disposed in the cover body, one end of the piston member combined to the sealing member; and

a covering measure, the covering measure covering the disc spring when the piston member drives the sealing member to move away from the inner end of the first pipe in order to allow an air inflow, such that the disc spring is prevented from being exposed to the flowing air and prevented from being stuck or attached by foreign objects.

In an embodiment of the present invention, the covering measure includes a sleeve provided with a fixing end and a free end. The fixing end is fixedly combined with the fixing member, and the free end surrounds the combining end of fixing member and the disc spring.

In an embodiment of the present invention, when the sealing member moves away from the inner end of the first pipe to the largest distance, the sealing member resists against the free end.

In an embodiment of the present invention, the covering measure includes a sleeve that is fixedly combined with the sealing member and surrounds the disc spring.

In an embodiment of the present invention, the cover body is provided with an inner space, and the piston member has a piston body slidingly disposed in the inner space. In addition, an air inflow portion is disposed at the cover body adjacent to the valve body, and the air inflow portion is connected with the inner space.

In an embodiment of the present invention, the piston body is connected with a controlling shaft. The controlling shaft passes through the fixing member and is connected with the sealing member.

In an embodiment of the present invention, the piston body is concavely provided with a spring recess; the cover body is provided with a sealed end; a spring is disposed between the spring recess and the sealed end.

In an embodiment of the present invention, a positioning member is inserted in the spring.

In an embodiment of the present invention, the sealed end of the cover body is provided with a silencing member, wherein the inner end of the silencing member contacts the inner space.

In an embodiment of the present invention, a heating device is further provided for heating the valve body.

In an embodiment of the present invention, a heat insulating plate is further provided and disposed between the valve body and the cover body.

With such configuration, through the covering measure, when the sealing member opens to allow the air flow, the disc spring is covered in the sleeve, so as to prevent the disc spring from being stuck or attached by foreign matters or objects, thereby avoid the incompletion of the disc spring movement.

Furthermore, the heating device is used to heat the valve body, such that when the first pipe is opened, the micro-size foreign matters or objects are burned by the high temperature heat. Therefore, the foreign objects are unable to be accumulated in the pipe.

### BRIEF DESCRIPTION OF THE DRAWINGS

FIG. 1 is a sectional view of a known right angle valve.

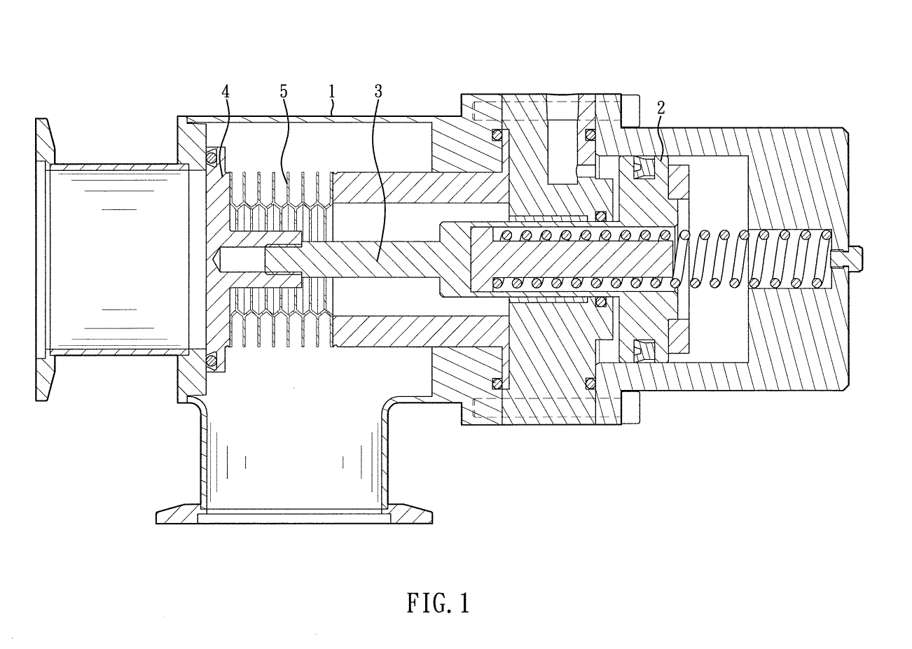

FIG. 2 is a sectional view of a right angle valve in accordance with an embodiment of the present invention, illustrating the first pipe being blocked.

FIG. 3 is a sectional view of the right angle valve in accordance with an embodiment of the present invention, illustrating the first pipe being gradually opened.

FIG. 4 is a sectional view of the right angle valve in accordance with an embodiment of the present invention, illustrating the first pipe being completely opened and the disc spring being covered.

FIG. 5 is a sectional view of the right angle valve in accordance with a second embodiment of the present invention, illustrating the first pipe being blocked and the sleeve being fixedly combined with the sealing member.

FIG. 6 is a sectional view of the right angle valve in accordance with the second embodiment of the present invention, illustrating the first pipe being completely opened and the disc spring being covered.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

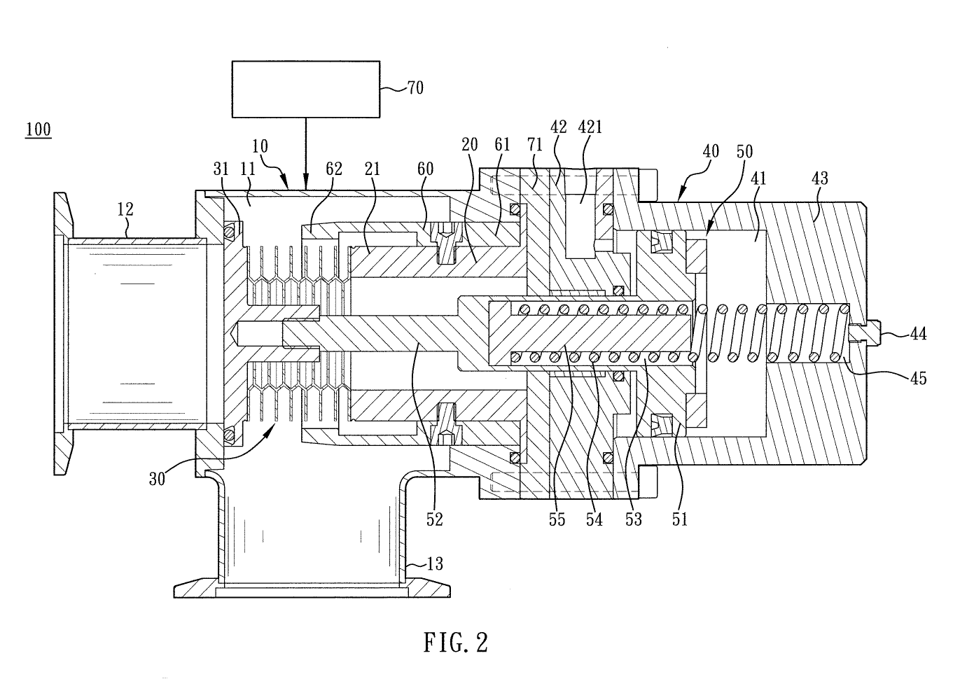

Referring to FIG. 2 to FIG. 4, the right angle valve 100 provided by an embodiment of the present invention comprises a valve body 10, a fixing member 20, a disc spring 30, a cover body 40, and a piston member 50.

The valve body 10 is a three way pipe, comprising a cavity 11 and a first pipe 12 and a second pipe 13 that are connected with the cavity 11. The first pipe 12 and the cavity 11 are arranged in an axial alignment. The first pipe 12 and the second pipe 13 form a right angle arrangement.

The fixing member 20 is formed in a barrel shape structure and fixed on one end of the valve body 10 away from the first pipe 12. The fixing member 20 is provided with a combining end 21 inserted into the cavity 11.

The disc spring 30 has one end thereof combined with a combining end 21 of the fixing member 20, while the other end thereof is connected with a sealing member 31 for sealing the inner end of the first pipe 12, so as to optionally open or close to allow or block the connection between the first pipe 12 and the cavity 11.

The cover body 40 is fixed on one end of the valve body 10 away from the first pipe 12 and arranged on the outer side of the fixing member 20. The cover body 40 includes an inner space 41. An air inflow portion 42 is disposed on the cover body 40 adjacent to the valve body 10. The air inflow portion 42 comprises an air inlet 421 which is connected with the inner space 41 for contacting an outer air source, such that the air is input into the inner space 41. Furthermore, one end of the cover body 40 away from the air inflow portion 42 is provided with a sealed end 43. The sealed end 43 includes a silencing member 44, wherein the inner end of the silencing member 44 is connected with the inner space 41 for balancing the inner pressure and the outer pressure of the cover body 40. In addition, the sealed end 43 of the cover body 40 is provided with a positioning recess 45 which is connected with the inner space 41 and the inner end of the silencing member 44.

The piston member 50 is slidingly disposed inside the cover body 40. In an embodiment of the present invention, the piston member 50 includes a piston body 51 which is slidingly disposed in the inner space 41. The piston body 51 is combined with a controlling shaft 52. The controlling shaft 52 pass through the air inflow portion 42 and the fixing member 20, wherein one end of the controlling shaft 52 is combined with the sealing member 31. When the piston member 50 moves, the sealing member 31 optionally opens or closes the first pipe 12. Further, the piston body 51 is axially and concavely provided with a spring recess 53 which receives a spring 54, such that the spring 54 is disposed between the spring recess 53 and the positioning recess 45 of the sealed end 43, thereby providing the recovering function of the piston member 50. In addition, a positioning member 55 is disposed in the spring recess 53, and the positioning member 55 is formed in a T shape, so as to be inserted into the spring 54 in order to position the spring 54.

An embodiment of the present invention further comprises a covering measure. When the piston member 50 drives the sealing member 31 to move away from the inner end of the first pipe 12 and enables the air to flow, the disc spring 30 is covered, so that the disc spring 30 is prevented from being exposed to the flowing air. As a result, the disc spring 30 is not stuck and attached by foreign objects or dust in the air, facilitating the normal operation of the disc spring 30.

The covering measure includes a sleeve 60, which comprises a fixing end 61 and a free end 62. The sleeve 60 is mounted around the fixing member 20, such that the fixing end 61 is fastened with the fixing member 20 by use of screws or bolts, and the free end 62 surrounds the combining end 21 of the fixing member 20 and the disc spring 30. Also, the outer diameter of the free end 62 of the sleeve 60 is substantially equal to the outer diameter of the sealing member 31. When the sealing member 31 moves away from the inner end of the first pipe 12 to the largest distance, one end of the sealing member 31 away from the inner side of the first pipe 12 contacts the free end 62, forming a blockage status. Also, the sealing member 31 seals the free end 62 of the sleeve 60, whereby the disc spring 30 is completely compressed into the sleeve 60. Therefore, a covering and protecting effect is provided upon the disc spring 30.

Furthermore, an embodiment of the present invention includes a heating device 70, which heats the valve body 10 by in a contact or non-contact manner. By use of heating, when the first pipe 12 is opened, the micro size foreign objects or matters are burned in a high temperature environment. Therefore, foreign objects do not stick or accumulate in the pipe.

Also, a heat insulating plate 71 is disposed between the valve body 10 and the cover body 40. When the heating device 70 heats the valve body 10, the heat is transmitted to the cover body 40, so as to prevent the adverse effects due to the operation of the piston member 50 and the air leakage from happening.

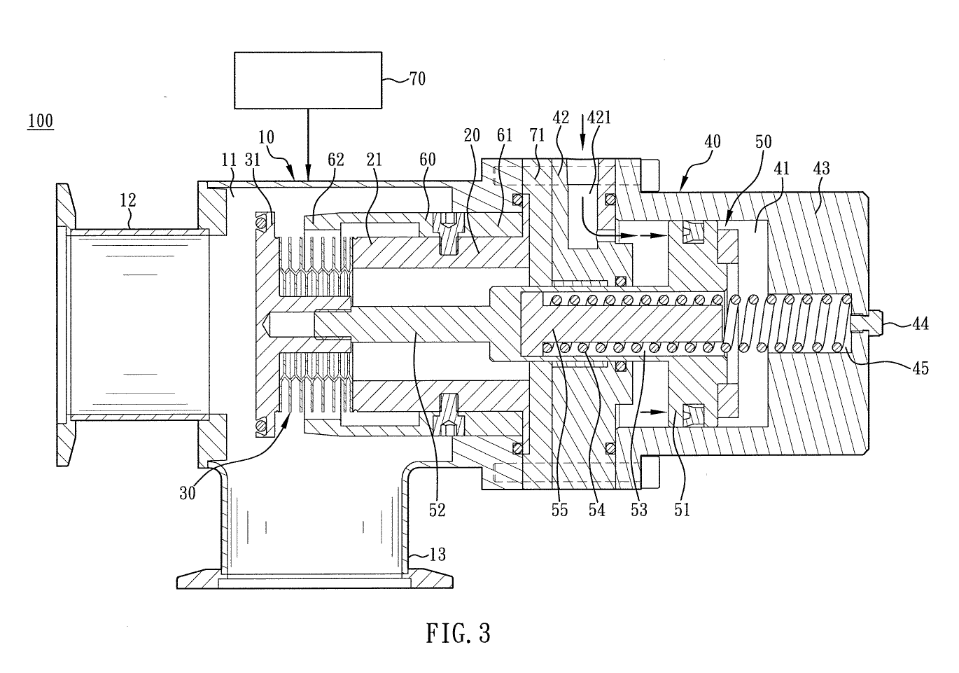

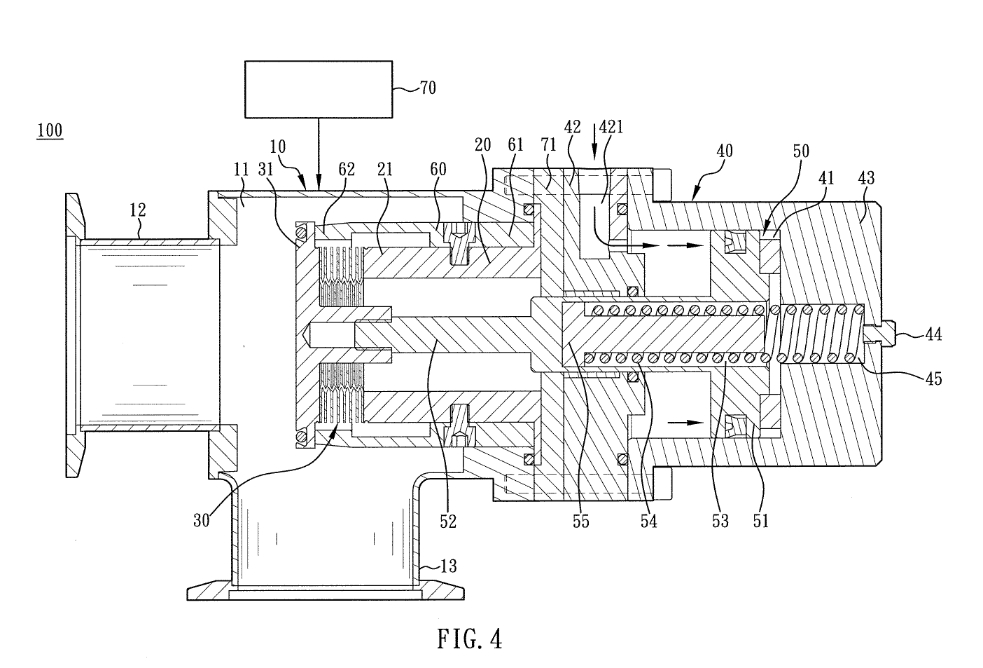

Referring to FIG. 3 and FIG. 4, the piston member 50 moves to open the first pipe 12. As shown by FIG. 3, by inputting a high pressure air from the outside, when the piston member 50 pushes the piston body 51 to move toward the sealed end 43 of the cover body 40, the piston body 51, by use of the controlling shaft 52, drives the sealing member 31 to gradually move away from the inner end of the first pipe 12, whereby the connection between the first pipe 12 and the second pipe 13 is established. At the meantime, the disc spring 30 bears a force to be compressed. As shown by FIG. 4, when the piston body 51 reaches the movement limitation, the first pipe 12 is completely opened, and the inner surface of the sealing member 31 resists against the free end 62 of the sleeve 60 to form a blockage structure, such that the disc spring 30 is completely covered in the sealing member 31 and the sleeve 60. Therefore, when the air is flowing, the disc spring 30 is prevented from being exposed in the flowing air, whereby the disc spring 30 is not stuck and attached by foreign objects and dust in the air, thus facilitating the normal operation of the disc spring 30. Further, when the valve is closed to block the high pressure air from the outside, by use of the resilient force provided by the disc spring 30 and the spring 54, the position of the piston member 50 is recovered, such that the first pipe 12 is blocked by the sealing member 31 to block the flowing air.

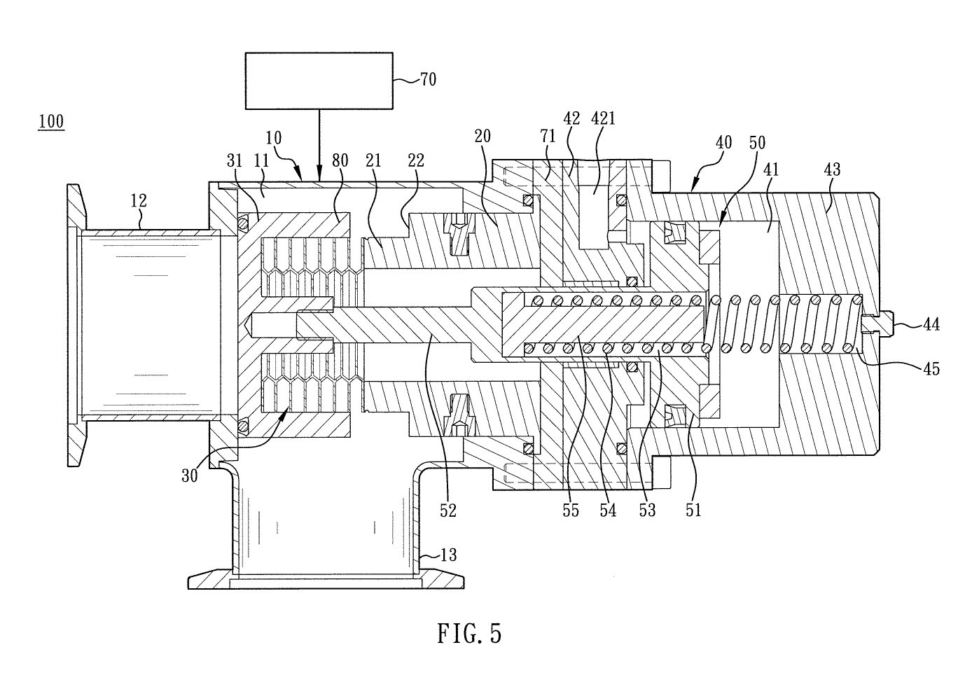

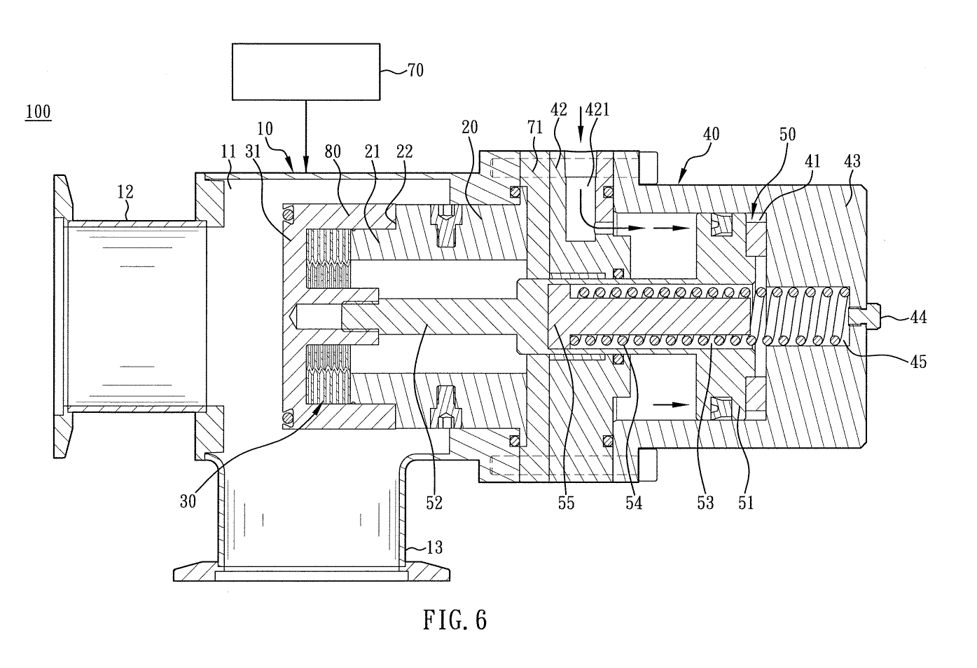

Referring to FIG. 5 and FIG. 6 illustrating another embodiment of the present invention, the elements/structures identical and similar to the corresponding elements cited in the previous drawing are marked with identical numberings. The covering measure includes a sleeve 80 which is fixedly combined with the sealing member 31 and surrounds the disc spring 30. The sleeve 80 is allowed to be integrally formed with the sealing member 31. Also, the combining end 21 of the fixing member 20 is provided with a held portion 22.

When the piston member 50 drives the sealing member 31 to open against the first pipe 12, the sleeve 80 gradually moves along with the sealing member 31 toward the fixing member 20; when the sealing member 31 is completely open against the first pipe 12, the sleeve 80 resists against the held portion 22 of the fixing member 20, whereby the disc spring 30 is completely covered, achieving the aforementioned covering and protecting effect.

To sum up, by use of the covering measure, when the sealing member 31 opens to allow the air flowing, the disc spring 30 is covered in the sleeve 60 or sleeve 80, such that the disc spring 30 is prevented from being stuck or attached by foreign objects in the flowing air, assuring the normal operation of the disc spring 30.

Furthermore, through the heating device 70 heating the valve body 10, when the first pipe 12 is opened, the foreign matters or objects in the valve body 10 are burned by the high temperature heat, preventing the foreign objects from sticking or accumulating in the pipe.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A right angle valve, comprising:
a valve body including a cavity and a first pipe and a second pipe connected with the cavity;
a fixing member fixed to the valve body, the fixing member provided with a combining end inserted into the cavity;
a disc spring with one end thereof combined to the combining end and the other end thereof connected with a sealing member for sealing an inner end of the first pipe;
a cover body fixed to an end of the valve body away from the first pipe;
a piston member slidingly disposed in the cover body, one end of the piston member combined to the sealing member; and
a covering measure, the covering measure covering the disc spring when the piston member drives the sealing member to move away from the inner end of the first pipe to allow an air inflow, such that the disc spring is prevented from being exposed to the flowing air.

2. The right angle valve of claim 1, wherein the covering measure includes a sleeve, the sleeve comprising a fixing end and a free end, the fixing end fixedly combined with the fixing member, the free end surrounding the combining end of the fixing member and the disc spring.

3. The right angle valve of claim 2, wherein the fixing end is fastened with the fixing member.

4. The right angle valve of claim 2, wherein when the sealing member moves away from the inner end of the first pipe to a largest distance, the sealing member resists against the free end.

5. The right angle valve of claim 1, wherein the covering measure includes a sleeve that is fixedly combined with the sealing member and surrounds the disc spring.

6. The right angle valve of claim 1, wherein the cover body is provided with an inner space, the piston member includes a piston body slidingly disposed in the inner space, and an air inflow portion connected with the inner space is disposed at the cover body adjacent to the valve body.

7. The right angle valve of claim 6, wherein the piston body is connected with a controlling shaft, the controlling shaft passing through the fixing member and is connected with the sealing member.

8. The right angle valve of claim 6, wherein the piston body is concavely provided with a spring recess, the cover body is provided with a sealed end, and a spring is disposed between the spring recess and the sealed end.

9. The right angle valve of claim 8, wherein a positioning member is disposed in the spring recess to be inserted in the spring.

10. The right angle valve of claim 8, wherein the sealed end of the cover body is provided with a silencing member, wherein an inner end of the silencing member contacts the inner space.

11. The right angle valve of claim 1, further comprising a heating device for heating the valve body.

12. The right angle valve of claim 11, further comprising a heat insulating plate disposed between the valve body and the cover body.
